(19) United States
(12) Patent Application Publication
(10) Pub. No.: US 2013/0050075 A1
(43) Pub. Date: Feb. 28, 2013

(54) CAPACITIVE POINTING DEVICE

(71) Applicants: Jaoching LIN, Taipei City (TW); Linabel CHU, Taipei City (TW); Gary LEE, New Taipei City (TW); Chang-Hong CHEN, Taipei City (TW); Ya-Jing WU, New Taipei City (TW)

(72) Inventors: Jaoching LIN, Taipei City (TW); Linabel CHU, Taipei City (TW); Gary LEE, New Taipei City (TW); Chang-Hong CHEN, Taipei City (TW); Ya-Jing WU, New Taipei City (TW)

(73) Assignee: HOWAY CORP., Kaohsiung City (TW)

(21) Appl. No.: 13/558,568

(22) Filed: Jul. 26, 2012

(30) Foreign Application Priority Data
Aug. 2, 2011 (TW) 100214246

(51) Int. Cl. G09G 5/08

(52) U.S. Cl. 345/157

(57) ABSTRACT

A capacitive pointing device includes a capacitive sensor unit, a switch unit, and an operating unit. The capacitive sensor unit has a receiving space receiving the switch unit, and a plurality of capacitive sensors disposed around the receiving space. The operating unit is spaced apart from the capacitive sensors, and is configured to result in a capacitance effect with the capacitive sensors. The operating unit is movable toward the capacitive sensor unit to trigger the switch unit, and is movable horizontally relative to the capacitive sensors. Capacitance variation between the operating unit and each of the capacitive sensors is used for determining a moving direction and an amount of movement of the operating unit.

### CROSS-REFERENCE TO RELATED APPLICATION

This application claims priority of Taiwanese Application No. 100214246, filed on Aug. 2, 2011.

### BACKGROUND OF THE INVENTION

1. Field of the Invention

The present invention relates to a pointing device, more particularly to a capacitive pointing device.

2. Description of the Related Art

Normally, a computer, a mobile phone, a personal digital assistant and other electronic devices are provided with a conventional pointing device, e.g., a mouse, a trackball and cursor movement keys, for moving a cursor on a screen and for selecting an option on an input interface. However, the conventional pointing device generally includes a lot of mechanical components so that an electronic device provided with such conventional pointing device may have a relatively large volume. For example, a conventional joystick used as the conventional pointing device generally includes a twist handle, a plurality of electric conductors, and a plurality of sensors for detecting the electric conductors. When a user operates the twist handle to incline toward a desired direction, the conventional joystick is operable to determine the desired direction according to detecting result from the sensors. However, application of the conventional joystick is limited due to a relatively greater height and incompact structure thereof.

There is another type of the conventional pointing device that uses a Hall element. This type of the conventional pointing device is operable, via magnetic induction, to detect a direction and an amount of movement of an input mechanism operated by a user. However, a manufacturing procedure of this type of the conventional pointing device is relatively complicated.

### SUMMARY OF THE INVENTION

Therefore, an object of the present invention is to provide a capacitive pointing device integrated with a switch and having a relatively small size and compact structure.

Accordingly, a capacitive pointing device of the present invention comprises a capacitive sensor unit, a switch unit, and an operating unit.

The capacitive sensor unit is formed with a receiving space receiving the switch unit, and includes a plurality of capacitive sensors that are disposed around the receiving space. The operating unit is spaced apart from the capacitive sensors, and is configured to result in a capacitance effect with the capacitive sensors.

The operating unit is movable toward the circuit board to trigger the switch unit, and is movable horizontally relative to the capacitive sensors. Capacitance variation between the operating unit and each of the capacitive sensors is used for determining a moving direction and an amount of movement of the operating unit.

### BRIEF DESCRIPTION OF THE DRAWINGS

Other features and advantages of the present invention will become apparent in the following detailed description of the preferred embodiments with reference to the accompanying drawings, of which:

FIG. 1 is an exploded perspective view of a first preferred embodiment of a capacitive pointing device according to this invention;

FIG. 2 is a cross-sectional view of the capacitive pointing device of the first preferred embodiment;

FIG. 3 is a schematic view illustrating a relative position between a conductive plate and an annular electric conductor of the capacitive pointing device of the first preferred embodiment;

FIG. 4 is a schematic view illustrating the conductive plate moving rightward relative to the annular electric conductor;

FIG. 5 is a cross-sectional view of a second preferred embodiment of a capacitive pointing device according to this invention;

FIG. 6 is a perspective view of a metallic sleeve of the capacitive pointing device of the second preferred embodiment;

FIG. 7 is an exploded perspective view of a third preferred embodiment of a capacitive pointing device according to this invention;

FIG. 8 is a cross-sectional view of the capacitive pointing device of the third preferred embodiment;

FIG. 9 is a schematic view illustrating a cavity in a capacitive sensor unit of the capacitive pointing device for receiving a switch unit that includes a contacting plate disposed over the cavity;

FIG. 10 is a schematic view illustrating a central contact and a peripheral contact that are disposed in the cavity; and

FIG. 11 is across-sectional view of the capacitive sensor unit of FIG. 9.

### DETAILED DESCRIPTION OF THE PREFERRED EMBODIMENTS

Before the present invention is described in greater detail, it should be noted that like elements are denoted by the same reference numerals throughout the disclosure.

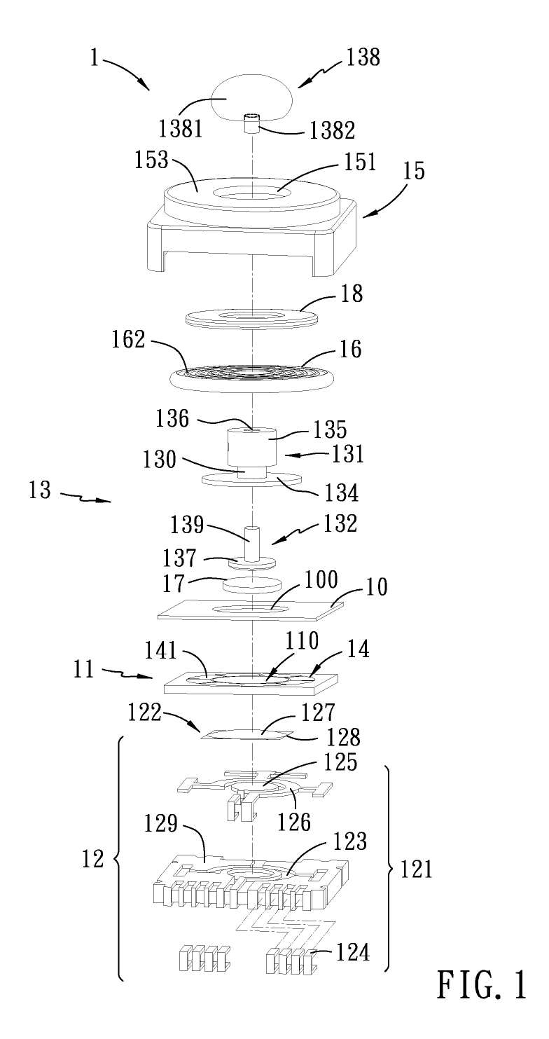

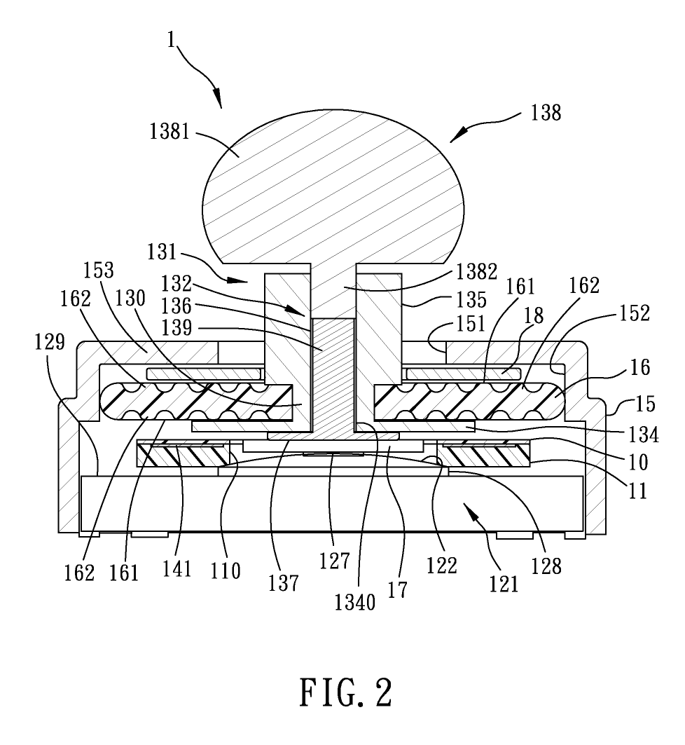

Referring to FIGS. 1 and 2, a first preferred embodiment of a capacitive pointing device 1 according to this invention is configured to be applied to an electronic device (not shown), such as a notebook computer, a mobile phone, or a personal digital assistant.

The capacitive pointing device 1 is operable, according to user operation, to control a moving direction of a movable pointer (for example, a cursor or a pick marker on a menu) on a screen of the electronic device. The capacitive pointing device 1 includes a capacitive sensor unit 11, a switch unit 12, an operating unit 13 and a housing 15. The housing 15 receives various components of the capacitive pointing device 1, is formed with an opening 151, and has an inner surface 152 perpendicular to the capacitive sensor unit 11 and a top wall 153 perpendicular to the inner surface 152.

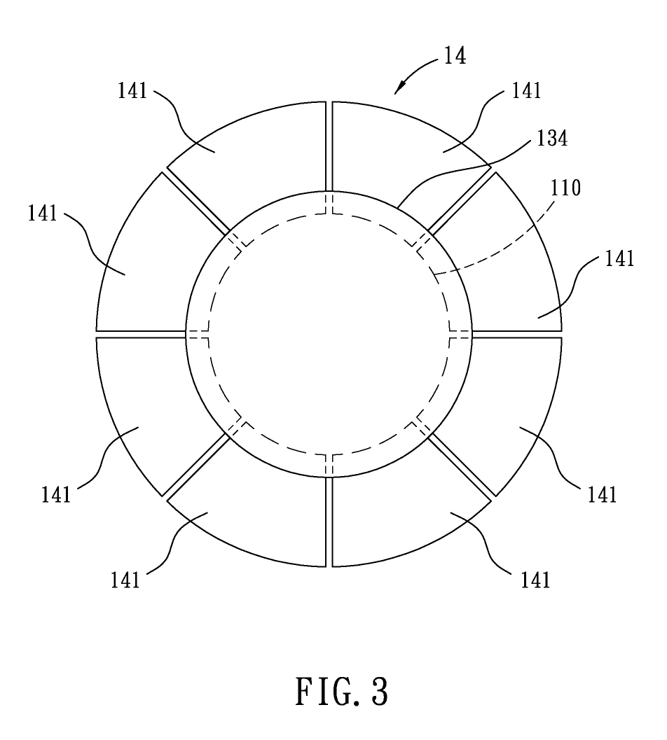

The capacitive sensor unit 11 is in a form of a circuit board that is formed with a receiving space 110, and includes a plurality of capacitive sensors 141 that are disposed around the receiving space 110. In this embodiment, the circuit board of the capacitive sensor unit 11 is formed with a through hole serving as the receiving space 110, and the capacitive sensor unit 11 includes eight capacitive sensors 141, each of which is an electric conductor, for example, a piece of copper foil. As shown in FIG. 3, the capacitive sensors 141 are angularly spaced apart from each other, are disposed on a surface of the circuit board of the capacitive sensor unit 11 around the through hole, and cooperate to form an annular electric conductor 14.

The switch unit 12 is disposed in the receiving space 110, and includes a base 121 and a contacting plate 122.

The base 121 is, for example, an electrical-insulating substrate, and has a surface 129 facing the operating unit 13 and being formed with a recess area 123. The recess area 123 includes a central portion and a peripheral portion provided with a central contact 125 and a peripheral contact 126, respectively, and the central contact 125 and the peripheral contact 126 are electrically connected to terminals 124 that are disposed at an outer side of the base 121 and that are configured to be electrically connected to another electronic component (not shown). The contacting plate 122 is disposed on the surface 129 of the base 121, and is made of an elastic conductive material. In particular, the contacting plate 122 includes a central arched part 127 that is disposed in the receiving space 110 and that is spaced apart from and registered with the central contact 125, and a rim part 128 that surrounds the central arched part 127 and that is electrically connected to the peripheral contact 126.

In this embodiment, the operating unit 13 is spaced apart from the capacitive sensors 141 of the capacitive sensor unit 11, and is disposed over the capacitive sensors 141 relative to the switch unit 12 so as to result in a capacitance effect with the capacitive sensors 141. Further, the operating unit 13 is movable horizontally relative to the annular electric conductor 14 formed by the capacitive sensors 141, and is movable toward the switch unit 12 disposed in the receiving space 110 of the capacitive sensor unit 11. In addition, an insulating layer 10 is disposed between the operating unit 13 and the annular electric conductor 14 for insulating the operating unit 13 from the annular electric conductor 14. For example, the insulating layer 10 is a polyester film (such as biaxially-oriented polyethylene terephthalate (BoPET), Mylar), or a polytetrafluoroethylene (PTFE) coating applied on a surface of the annular electric conductor 14 that faces the operating unit 13 or applied on the operating unit 13. In particular, the switch unit 12, the capacitive sensor unit 11, the insulating layer 10, and the operating unit 13 are disposed in the housing 15 in sequence.

The operating unit 13 has a lower end facing the annular electric conductor 14 formed by the capacitive sensors 141 and having a projected image that partially overlaps the annular electric conductor 14 as best shown in FIG. 3. The movement of the operating unit 13 toward a moving direction increases the overlapping area between the projected image of the lower end of the operating unit 13 onto the annular electric conductor 14 at the moving direction, and accordingly results in an increased amount of capacitance variation between the operating unit 13 and each of the capacitive sensors 141 at the moving direction. Thus, the capacitance variation between the operating unit 13 and each of the capacitive sensors 141 may be used for determining the moving direction and an amount of movement of the operating unit 13. In practice, the capacitive sensors 141 maybe coupled to a detector (not shown) for detecting the capacitance variation between the operating unit 13 and each of the capacitive sensors 141. Moreover, when the operating unit 13 is pressed to move toward the switch unit 12 disposed in the capacitive sensor unit 11, the lower end of the operating unit 13 will press the central arched part 127 of the contacting plate 122 to move toward the central contact 125 such that the central arched part 127 is electrically connected to the central contact 125 disposed on the base 121 of the switch unit 12 so as to trigger the switch unit 12.

In this embodiment, the operating unit 13 includes an operating rod 131. The operating rod 131 includes a rod body 130 having opposite ends, and an exposed part 135 disposed at one of the opposite ends of the rod body 130 remote from the capacitive sensor unit 11 and extending out of the housing 15 through the opening 151. The exposed part 135 has a dimension greater than a dimension of the rod body 130 in a radial direction perpendicular to a lengthwise direction along the opposite ends of the rod body 130, and is configured to allow a user to hold and to operate the operating unit 13. The other one of the opposite ends of the rod body 130 that is adjacent to the capacitive sensors 141 is provided with a conductive plate 134 that is parallel to the annular electric conductor 14 to result in the capacitance effect with the capacitive sensors 141, that has a diameter greater than an inside diameter of the through hole (i.e., the receiving space 110) and smaller than an outside diameter of the annular electric conductor 14, and that is movable horizontally relative to the capacitive sensors 141.

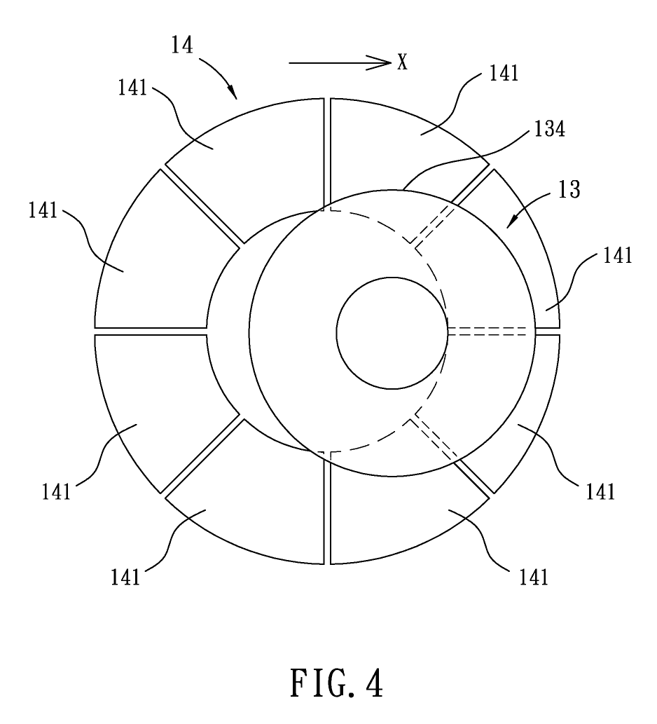

As shown in FIG. 4, the movement of the operating unit 13 toward the moving direction (X) increases the overlapping area between the projected image of the conductive plate 134 onto the annular electric conductor 14 at the moving direction (X) , and accordingly results in an increased amount of the capacitance variation between the conductive plate 134 and a part of the capacitive sensors 141 at the moving direction (X). At this time, an overlapping area between the projected image of the conductive plate 134 onto the annular electric conductor 14 at other directions and the capacitance variation between the conductive plate 134 and other capacitive sensors 141 at other directions are decreased. Then, the detector coupled to the capacitive sensors 141 maybe operable to send a signal, such as a voltage signal, to the capacitive sensors 141 so as to detect the capacitance variation between the conductive plate 134 and each of the capacitive sensors 141 when the capacitance effect occurs therebetween. Thus, the detector may be operable to determine the moving direction (X) of the movement of the operating unit 13 according to the capacitance detected from the capacitive sensors 141 at different directions.

In this embodiment, since the central arched part 127 of the contacting plate 122 is at a lower level than a surface of the capacitive sensor unit 11, that is to say, the central arched part 127 is not exposed from the receiving space 110 of the capacitive sensor unit 11, the operating unit 13 further includes a pressing component 132. In particular, the operating rod 131 is in a form of a tube having a central channel 136 extending through the operating rod 131, and the conductive plate 134 is formed with a through hole 1340 in spatial communication with the central channel 136 of the operating rod 131. The pressing component 132 includes a first end 138 remote from the conductive plate 134 and exposed from the exposed part 135, a second end 139 opposite to the first end 138 and disposed within the central channel 136 of the operating rod 131, and a pressing plate 137 connected to the second end 139 and exposed from the conductive plate 134. The pressing plate 137 has a diameter smaller than the inside diameter of the receiving space 110 of the capacitive sensor unit (i.e., the through hole). Further, the pressing plate 137 extends through a central through hole 100 of the insulating layer 10, and is adjacent to the switch unit 12, such that, when the first end 138 of the pressing component 132 is pressed to make the second end 139 move toward the switch unit 12, the pressing plate 137 presses the central arched part 127 of the contacting plate 122 to move toward the central contact 125 so as to trigger the switch unit 12. The conductive plate 134 and the pressing plate 137 of the pressing component 132 constitute the lower end of operating unit 13.

In this embodiment, the first end 138 of the pressing component 132 is a joystick including a head 1381 exposed from the exposed part 135 of the operating rod 131, and a connecting rod 1382 projecting from the head 1381 and being connected to the second end 139 of the pressing component 132. In other embodiments, the first end 138 may be in a form of a rod extending from the second end 139 and being exposed from the exposed part 135.

In addition, the pressing component 132 of the operating unit 13 maybe omitted in a case that the central arched part 127 of the contacting plate 122 and the central contact 125 are at higher levels than a surface of the capacitive sensor unit 11, that is to say, the central arched part 127 and the central contact 125 are exposed from the receiving space 110 of the capacitive sensor unit 11. In such case, a user can directly press the exposed part 135 to move the conductive plate 134 toward the central arched part 127, and then the conductive plate 134 presses the central arched part 127 to make the central arched part 127 be electrically connected to the central contact 125 disposed on the base 121 so as to trigger the switch unit 12.

In order to restore the operating unit 13, the capacitive pointing device 1 further includes an elastic component 16 disposed between the conductive plate 134 and the exposed part 135 of the operating unit 13 and surrounding the rod body 130 of the operating rod 131. The elastic component 16 is in a shape of a circular board having a diameter greater than a diameter of the conductive plate 134 in the direction parallel to the capacitive sensor unit 11, and abuts against the inner surface 152 of the housing 15. The elastic component 16 includes two surfaces 161 parallel to the conductive plate 134, and a plurality of concentric ring protrusions 162 formed on the surfaces 161 and being spaced apart from each other in radial directions. By virtue of the concentric ring protrusions 162, the elastic component 16 can be compressed uniformly and will not bulge out in a direction perpendicular to the radial direction.

The capacitive pointing device 1 further includes an insulating plate 17 disposed between the pressing plate 137 of the pressing component 132 and the switch unit 12, and a smooth plate 18 surrounding the operating rod 131 and being disposed between the elastic component 16 and the top wall 153 of the housing 15. By virtue of the insulating plate 17, a height of the central arched part 127 of the contacting plate 122 relative to the pressing plate 137 may be reduced so as to facilitate the pressing plate 137 pressing the contacting plate 122. Also, when the pressing plate 137 is not exactly registered with the contacting plate 122, the pressing plate 137 can still press the contacting plate 122 via the insulating plate 17 to trigger the switch unit 12. The smooth plate 18 is, for example, an annular iron sheet having a relatively smaller friction coefficient, and is configured to press the elastic component 16 to secure the elastic component 16. By virtue of the smooth plate 18, a frictional force between the top wall 153 of the housing 15 and the elastic component 16 is reduced.

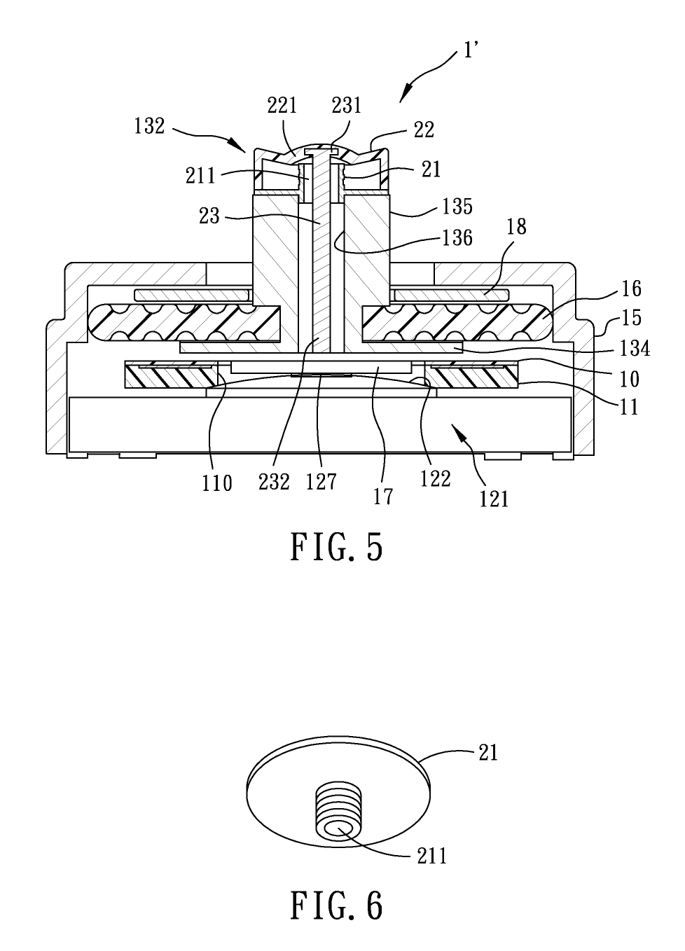

Referring to FIGS. 5 and 6, a second preferred embodiment of a capacitive pointing device 1′ according to this invention is shown to be similar to the capacitive pointing device 1 of the first preferred embodiment. In the second preferred embodiment, the pressing component 132 includes a metallic sleeve 21 disposed on the exposed part 135 of the operating rod 131, an elastic cap 22 disposed on the metallic sleeve 21, and a pressing stick 23 connected to the elastic cap 22 for pressing the contacting plate 122.

The metallic sleeve 21 is, for example, screwed to the exposed part 135, and is formed with an accommodating channel 211 in spatial communication with the central channel 136 in the operating rod 131. The elastic cap 22 is made of an insulating and elastic material (for example, elastic rubber), and includes a protruding button 221 at a top side that is remote from the exposed part 135. The pressing stick 23 is a T-shaped stick, and is movably disposed in the accommodating channel 211 and the central channel 136. The pressing stick 23 has a fastened end 231 fastened in the protruding button 221 of the elastic cap 22, and a pressing end 232 opposite to the fastened end 232 for pressing and triggering the switch unit 12 when the protruding button 221 is pressed. When a user presses the protruding button 221 of the elastic cap 22, the pressing stick 23 moves in the accommodating channel 211 and the central channel 136 toward the contacting plate 122, and then, the pressing end 232 presses the central arched part 127 of the contacting plate 122 such that the central arched part 127 is electrically connected to the central contact 125 on the base 121 of the switch unit 12 and the switch unit 12 is triggered. By virtue of the metallic sleeve 21 and the elastic cap 22, the pressing stick 23 is stable and will not sway in the accommodating channel 211 and the central channel 136.

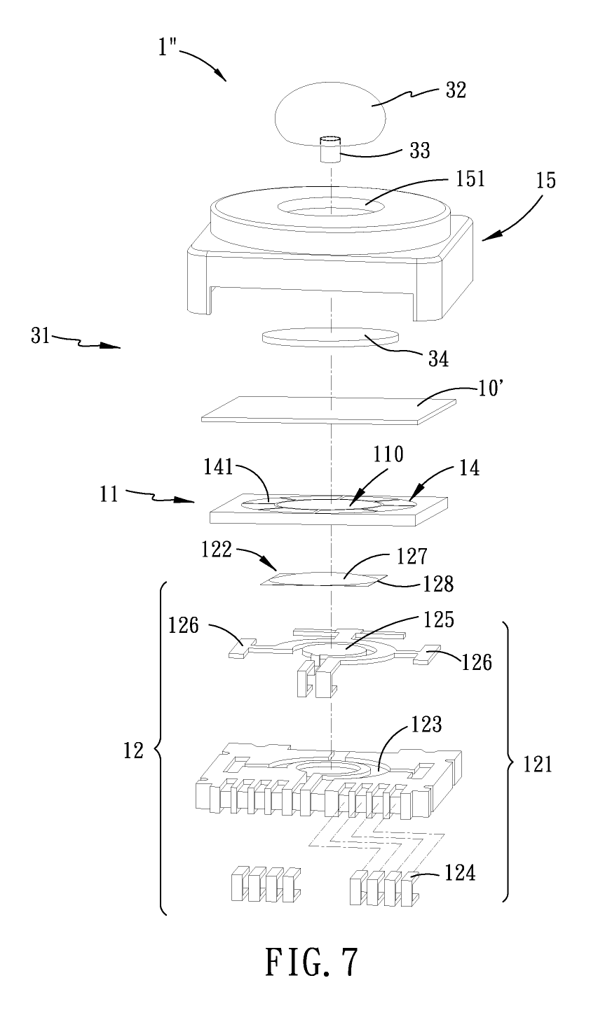

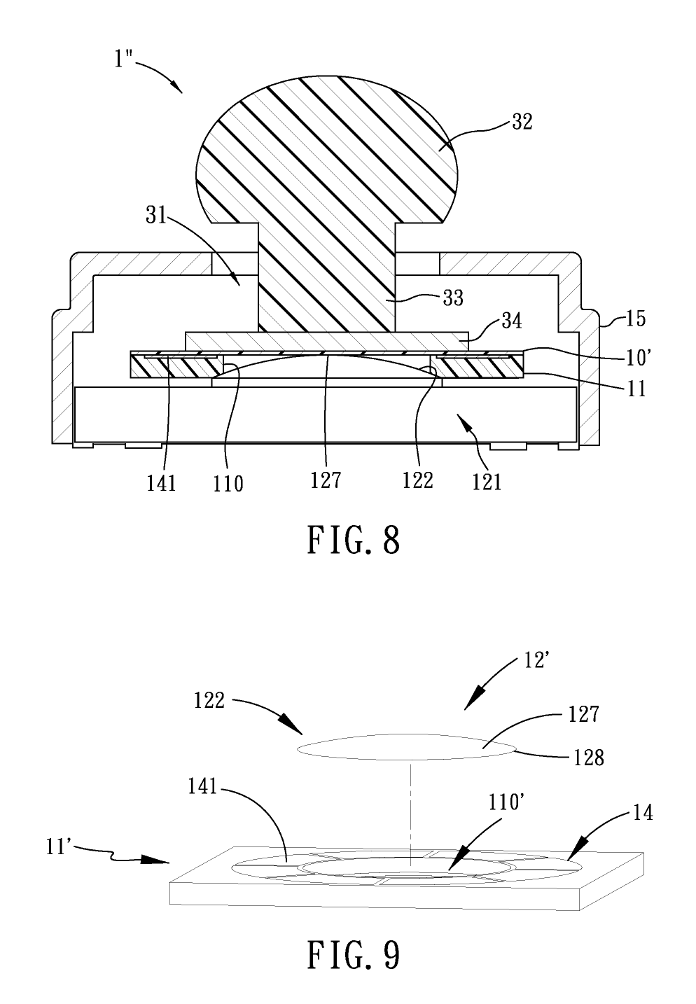

Referring to FIGS. 7 and 8, a third preferred embodiment of a capacitive pointing device 1″ according to this invention is shown to be similar to the capacitive pointing device 1 of the first preferred embodiment. In the third preferred embodiment, the capacitive pointing device 1″ includes an elastic operating component 31 for replacing the operating unit 13, the elastic component 16 and the smooth plate 18. The elastic operating component 31 includes a head portion 32, a rod portion 33 projecting from the head portion 32 toward the switch unit 12, and a conductive plate 34 connected to one end of the rod portion 33 opposite to the head portion 32. The conductive plate 34 is an elastic electric conductor. The method for detecting a moving direction of movement of the elastic operating component 31 and operation thereof are similar to those of the operating unit 13 of the first preferred embodiment, and therefore, details thereof will be omitted herein for the sake of brevity.

In this embodiment, since the central arched part 127 of the contacting plate 122 and the surface of the capacitive sensor unit 11 are at the same level (see FIG. 8), the conductive plate 34 may deform and directly press the central arched part 127 through the insulating layer 10′ by pressing the head portion 32 of the elastic operating component 31 toward the switch unit 12. Thus, the central arched part 127 is electrically connected to the central contact 125 disposed on the base 121 of the switch unit 12 so as to trigger the switch unit 12. Since the conductive plate 34 does not move through the insulating layer 10′ to press the central arched part 127, the insulating layer 10′ of this embodiment is not formed with a through hole.

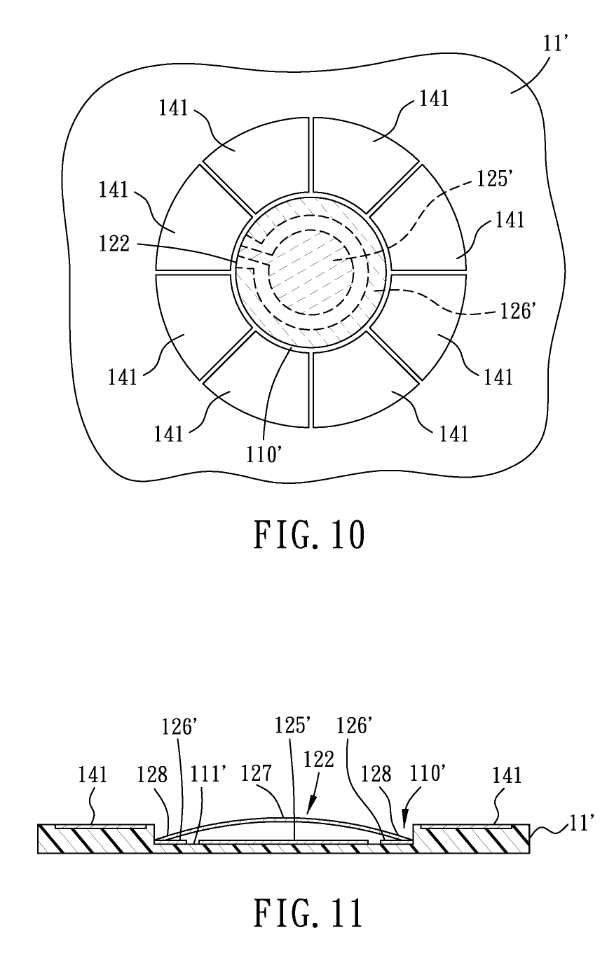

FIGS. 9 to 11 illustrate another example configuration of a capacitive sensor unit 11′ which is a circuit board formed with a cavity having a bottom surface 111′ and serving as a receiving space 110′ for receiving a switch unit 12′. The switch unit 12′ includes a central contact 125′ and a peripheral contact 126′ that are disposed in the receiving space 110′ on the bottom surface 111′ and that are electrically connected to other circuits (not shown) through the circuit board of the capacitive sensor unit 11′. The switch unit 12′ further includes a contacting plate 122 made of an elastic conductive material. The contacting plate 122 is disposed over the central contact 125′ and the peripheral contact 126′, and includes a central arched part 127 spaced apart from and registered with the central contact 125′ and a rim part 128 surrounding the central arched part 127 and electrically connected to the peripheral contact 126′. Since the operation and method for triggering the switch unit 12′ are similar to those of the first preferred embodiment, details thereof will be omitted herein for the sake of brevity.

To sum up, an overall size of the capacitive pointing device 1, 1′, 1″ of this invention is relatively smaller since the switch unit 12, 12′ is disposed in the receiving space 110, 110′ of the capacitive sensor unit 11, 11′ (e.g., the through hole or the cavity of the capacitive sensor unit 11, 11′). Further, a number of components of the capacitive pointing device 1, 1′, 1″ of this invention is relatively fewer, and a manufacturing cost of the capacitive pointing device 1, 1′, 1″ is reduced accordingly. By operating the operating unit 13 and the elastic operating component 31, a user can move a cursor on a screen of the electronic device provided with the capacitive pointing device 1, 1′, 1″ and trigger the switch unit 12, 12′.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A capacitive pointing device comprising:
a capacitive sensor unit formed with a receiving space, and including a plurality of capacitive sensors that are disposed around said receiving space;
a switch unit disposed in said receiving space; and
an operating unit spaced apart from said capacitive sensors and configured to result in a capacitance effect with said capacitive sensors, said operating unit being movable toward said capacitive sensor unit to trigger said switch unit and being movable horizontally relative to said capacitive sensors, capacitance variation between said operating unit and each of said capacitive sensors being used for determining a moving direction and an amount of movement of said operating unit.

2. The capacitive pointing device as claimed in claim 1, wherein said capacitive sensors of said capacitive sensor unit are conductive elements that cooperate to form an annular electric conductor, and said operating unit includes a conductive plate that is adjacent to and parallel to said capacitive sensors to result in the capacitance effect with said capacitive sensors, that has a diameter greater than an inside diameter of said receiving space and smaller than an outside diameter of said annular electric conductor, and that is movable horizontally relative to said capacitive sensors,
the movement of said conductive plate of said operating unit toward the moving direction increasing an overlapping area between a projected image of said conductive plate onto said annular electric conductor at the moving direction, and resulting in an increased amount of capacitance variation between said conductive plate and a part of said capacitive sensors at the moving direction.

3. The capacitive pointing device as claimed in claim 2, further comprising a housing formed with an opening and covering said capacitive sensor unit, said switch unit and said operating unit, said operating unit further including an operating rod extending from said conductive plate toward a direction opposite to said capacitive sensor unit and out of said housing through said opening.

4. The capacitive pointing device as claimed in claim 3, wherein said operating rod of said operating unit includes:
a rod body having opposite ends, one of which is connected to said conductive plate; and
an exposed part that is disposed at the other one of said opposite ends of said rod body, that is exposed from said housing, and that has a dimension greater than a dimension of said rod body in a radial direction perpendicular to a lengthwise direction along said opposite ends of said rod body.

5. The capacitive pointing device as claimed in claim 4, wherein said operating rod is in a form of a tube having a central channel extending through said operating rod, and said conductive plate is formed with a through hole in spatial communication with said central channel of said operating rod,
said operating unit further including a pressing component that includes a first end remote from said conductive plate and exposed from said exposed part, a second end opposite to said first end and disposed within said central channel of said operating rod, and a pressing plate connected to said second end, exposed from said conductive plate, and being adjacent to said switch unit so as to trigger said switch unit when said first end is pressed to make said pressing plate move toward said switch unit.

6. The capacitive pointing device as claimed in claim 5, wherein said first end of said pressing component is a joystick including a head exposed from said exposed part of said operating rod and a connecting rod projecting from said head and being connected to said second end.

7. The capacitive pointing device as claimed in claim 5, further comprising an insulating plate disposed between said pressing plate of said pressing component and said switch unit, said pressing plate being configured to press said insulating plate so as to trigger said switch unit.

8. The capacitive pointing device as claimed in claim 4, wherein said housing includes an inner surface perpendicular to said capacitive sensor unit, and said capacitive pointing device further comprises an elastic component that is disposed between said conductive plate and said exposed part of said operating rod, that surrounds said rod body of said operating rod, that is in a shape of a circular board having a diameter greater than that of said conductive plate in the direction parallel to said capacitive sensor unit, and that abuts against said inner surface of said housing.

9. The capacitive pointing device as claimed in claim 8, wherein said elastic component includes a surface parallel to said conductive plate, and a plurality of concentric ring protrusions formed on said surface and spaced apart from each other.

10. The capacitive pointing device as claimed in claim 8, wherein said housing further includes a top wall perpendicular to said inner surface, and said capacitive pointing device further comprises a smooth plate that surrounds said operating rod, that is disposed between said elastic component and said top wall, and that has a relatively smaller friction coefficient.

11. The capacitive pointing device as claimed in claim 4, wherein said operating rod is in a form of a tube having a central channel through said rod body and said exposed part, and said conductive plate is formed with a through hole in spatial communication with said central channel of said operating rod,
said operating unit further including
a metallic sleeve disposed on said exposed part and formed with an accommodating channel in spatial communication with said central channel,
an elastic cap disposed on said metallic sleeve and made of an insulating material, and
a pressing stick movably disposed in said accommodating channel and said central channel, and having a fastened end fastened in said elastic cap and a pressing end opposite to said fastened end for pressing and triggering said switch unit when said elastic cap is pressed.

12. The capacitive pointing device as claimed in claim 11, wherein said elastic cap has elasticity and includes a top surface that is opposite to said metallic sleeve and that protrudes to form a central button, said fastened end of said pressing stick being fastened in said central button, said pressing stick moving toward said switch unit to make said pressing end press and trigger said switch unit when said central button is pressed.

13. The capacitive pointing device as claimed in claim 2, wherein said operating unit is made of an elastic material, and said conductive plate of said operating unit is made of an elastic conductive material.

14. The capacitive pointing device as claimed in claim 13, wherein said conductive plate is made of conductive rubber.

15. The capacitive pointing device as claimed in claim 2, further comprising an insulating layer disposed between said conductive plate and said capacitive sensor unit.

16. The capacitive pointing device as claimed in claim 15, wherein said insulating layer is one of a polyester film and a polytetrafluoroethylene (PTFE) coating applied on surfaces of said capacitive sensors that face said conductive plate.

17. The capacitive pointing device as claimed in claim 1, wherein said capacitive sensor unit is formed with a through hole serving as said receiving space, and said switch unit includes:
a base having a surface that faces said operating unit and that is provided with a central contact and a peripheral contact; and
a contacting plate made of an elastic conductive material, disposed on said surface of said base, and including a central arched part disposed in said receiving space and spaced apart from and registered with said central contact so as to contact said central contact when said operating unit moves toward said capacitive sensor unit to press said contacting plate, and a rim part surrounding said central arched part and electrically connected to said peripheral contact.

18. The capacitive pointing device as claimed in claim 1, wherein said capacitive sensor unit is formed with a cavity serving as said receiving space and has a bottom surface facing said operating unit, and said switch unit includes:
a central contact and a peripheral contact that are disposed on said bottom surface; and
a contacting plate made of an elastic conductive material, and including a central arched part spaced apart from and registered with said central contact so as to contact said central contact when said operating unit moves toward said capacitive sensor unit to press said contacting plate, and a rim part surrounding said central arched part and electrically connected to said peripheral contact.
